(19) United States
(12) Patent Application Publication
(10) Pub. No.: US 2019/0080407 A1
(43) Pub. Date: Mar. 14, 2019

(54) SYSTEM AND METHOD OF PROVIDING UNIQUE IDENTIFIERS IN SECURITY BLOCKCHAIN-BASED TOKENS

(71) Applicant: TEMPLUM, INC., New York, NY (US)

(72) Inventors: Vincent MOLINARI, Laurel Hollow, NY (US); Christopher PALLOTTA, New York, NY (US); Joseph LATONA, Monroe Township, NJ (US)

(21) Appl. No.: 16/126,975

(22) Filed: Sep. 10, 2018

Related U.S. Application Data
(63) Continuation of application No. 15/958,801, filed on Apr. 20, 2018.
(60) Provisional application No. 62/556,568, filed on Sep. 11, 2017.
(60) Provisional application No. 62/560,267, filed on Sep. 19, 2017.

(51) Int. Cl. G06Q 40/04; G06Q 20/06; H04L 9/06; G06Q 20/22; G06Q 40/02; G06Q 40/06

(52) U.S. Cl. CPC G06Q 40/04; G06Q 20/06; H04L 9/0637; G06Q 20/223; H04L 2209/38; G06Q 40/02; G06Q 40/06

(57) ABSTRACT

A method includes generating CUSIP unique identifiers that are embedded in each token of a tokenized asset offering that is blockchain-based. Cryptocurrency wallets associated with managing tokens can also each have a unique identifier. As an alternative trading system manages trades of tokens having unique identifiers with buyers and sellers having wallets with associated unique identifiers, a reporting of transaction data can be made to a transfer agent that is registered with the a regulatory agency. Separately recording transaction data from the data recorded on the blockchain can enable the transfer agent to be the arbiter of ownership. Having the transaction data stored by the transfer agent can reduce or eliminate the incentive to hacked security wallets, can enable audits, and can enable regulatory compliance when thresholds, such as a number of shareholders, are met.

### PRIORITY

This application is a continuation of U.S. application Ser. No. 15/958,801, filed Apr. 20, 2018, which claims priority to U.S. Provisional Application No. 62/556,568, filed Sep. 11, 2017, the contents of each of which are herein incorporated by reference in their entireties.

This application claims priority to U.S. Provisional Application No. 62/560,267, filed Sep. 19, 2017, the content of which is herein incorporated by reference in its entirety.

### RELATED APPLICATIONS

The present application is related to Applications have Docket Nos. 155-0002-NP, 155-0003-NP, and 155-0004-NP filed on the same day as the present application. Each of these applications is incorporated herein by reference.

### TECHNICAL FIELD

The present disclosure relates to the escrow wallets for blockchain-based tokens and improvements in a number of areas including providing unique identifiers to security tokens and improved technologies associated with the use of transfer agents registered with the Securities and Exchange Commission (or other government entity) for the purpose of being the arbiter of token of ownership.

### BACKGROUND

In the rapid evolution of the acceptance of initial coin offerings (ICOs) and tokenized product offerings, or any other digital asset offerings, there currently exists significant confusion about, lack of understanding of, and disregard for the manner in which monies are aggregated into tokens, and what a token actually represents. The way tokens are generated electronically and sold or offered to buyers, and the associated confusion about what they are and represent illustrates a technical problem with respect to ICOs, how tokens are offered and how they are issued, traded and used on a computer network. There is also a lack of a centralized recorder keeper for tokens issued in initial coin offerings. There is no place where investors can to for basic data which is normally available for securities that can be bought and sold. Many trades or hacking of cryptocurrency wallets can occur anonymously.

An ICO is an unregulated means of crowdfunding via use of cryptocurrency. The term is often confused with term “token sale” or “crowdsale”, which refers to a method of selling participation in an economy, giving investors access to the features of a particular project starting at a later date. ICOs, on the other hand, sell a right of ownership or royalties to a project. The “coin” in an ICO is a symbol or a token of ownership interest in an enterprise. It is like a digital stock certificate. In contrast to initial public offerings (IPOs), where investors gain shares in the ownership of the company, for ICOs, the investors buy coins of the company, which can appreciate in value if the business is successful.

Tokens typically take the form of a utility or special purpose token to be utilized within the ecosystem of the issuer. However, in many cases, tokens including a profit participation or revenue share determined by the token issuer are actually securities when the Howey test is applied to the tokens.

The success of ICOs has become a favorite subject of the global media due to the rapid time in which capital is aggregated and also the sheer size of token sales, which may eclipse hundreds of millions of dollars in a single issuance within weeks. This has led to tokens being misused and investors misconstruing what the tokens actually represent.

There is a significant deficiency in the messaging and the regulatory framework and protocols of what a token actually is—often, a security—and the manner in which tokens are raised. Inadequate messaging and protocols result in investors being exploited and left unprotected in the marketplace. Nefarious and anonymous activity can occur in ICOs and trading blockchain-based tokens. This is a problem having its foundation in computer networks and computer-based technology with respect to ICOs.

Furthermore, given the nature of ICOs, it becomes difficult to comply with Rule 12G regulations such as when a certain company reaches a threshold number of shareholders, an affirmative obligation to file documents with the securities and exchange commissions is triggered. Often, the company will not know in an ICO when the threshold number of shareholders is met.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system configuration;

FIGS. 2A-2C illustrate a blockchain network;

FIG. 3A illustrates an example CUSIP identifier and an example environment associated with providing unique identifiers for security tokens and wallets;

FIG. 3B illustrates the unique identifier for tokens as part of a transaction;

FIG. 4 illustrates a method embodiment;

FIG. 5 illustrates a method embodiment;

FIG. 6 illustrates an example environment associated with shareholder headcount and compliance with regulations;

FIG. 7 illustrates a method embodiment;

FIG. 8 illustrates the use of a transfer agent;

FIG. 9 illustrates a method embodiment;

FIG. 10 illustrates a transfer agent acting as a custodian;

FIG. 11 illustrates a method embodiment; and

FIG. 12 illustrates another method embodiment.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. There is a significant need for a framework which facilitates clear issuance of tokens as securities and in compliance with regulatory law and which has a technical component related to how tokens are issued and sold.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present disclosure shall discuss techniques for providing various improvements to the use of digital assets or tokens, and particularly with respect to the integrated use of a record-keeper such as a transfer agent or registrar that is appropriately registered with a regulatory government agency. Currently, with digital assets, there is no mechanism for an investor to find out all of the necessary information needed to evaluate or determine the value of a particular token. Some individuals may have much more information than other individuals on both sides of the trade. Given the lack of parity of information which can exist between parties to a trade, individuals can take advantage of one another in ways that are not possible in the normal securities infrastructure.

The proliferation of digital assets that have taken place over the last several years has resulted in a large number of individual assets which are not currently well suited to be integrated into traditional financial services infrastructure. These digital assets, which are blockchain-based, when issued pursuant to a registration statement or an applicable exemption under the federal securities laws, can have an important role to play in the overall financial services industry. Digital assets that are securities represent a development in transparency and democratization in investing facilitated by blockchain technology. However, the use of digital assets as securities requires their integration into the traditional financial services industry. Such integration includes providing digital assets with the attributes of traditional securities, including the use of identifiers such as the CUSIP identifiers. CUSIP stands for Committee on Uniform Security Identification Procedures. The use of such identifiers can provide a technical solution to enable the continuity of information across all parties interested in a particular token, such that one party does not have an unfair advantage over the other. A similar system can be used to identify foreign securities using a CUSIP International Numbering System or CINS. A CGS ISIN number is a unique global code that identifies instruments to facilitate cross-border trading. The name stands for CUSIP Global Services International Securities Identification Numbers. The ISIN number includes a country code, having 2 characters, a local identifier, having 9 characters, a check value having a single character, which combines to yield an ISIN identifier of 12 characters. These represent example unique identifiers having a particular protocol for identifying such data as a country of origin, an issuer of a token, the token itself, a check code, a regional identifier, the buyer or seller identifier, and so forth.

While blockchain technology is well-suited for tracking the issuance and transfer of assets through the use of the distributed ledger system, this functionality is not designed for use in the current financial services infrastructure and also carries as degree of risk, particularly related to hacking in the context of digital assets. The identifiers disclosed herein can help facilitate traceability and ownership authentication of digital assets to a degree that currently does not technically exist on the blockchain. Digital assets are vulnerable to hacking and once stolen, digital assets typically cannot be recovered as the data that is hacked associated with a token is like a better instrument in which the holder is presumed to be the owner. Using the identifiers disclosed herein will allow digital assets that are hacked to be retrieved by the rightful owner as the identifiers embedded in a respective token can be used to track legal ownership of the securities. This traceability will help to legitimize the financial technology industry by reducing potential threats to ownership. The ability to track ownership through identifiers also allows for stock transfer orders, which will reduce the incentive for hacking. With this new infrastructure in place, a hacker would know that if the hack is detected, the transfer of the applicable security can be stopped. It also provides for increased investor protection as the solution disclosed herein leaves investors less vulnerable to having their assets stolen. The identifiers have the potential to also benefit digital assets that are currencies by providing an easier anti-money laundering compliance in combating cyber terrorism and illicit activities through record-keeping and auditability.

In order for digital assets that are securities to be widely adopted by investors and issuers, a technical solution to these problems outlined above needs to be provided. Applying the use of CUSIP identifiers (or the like) to tokenized asset offerings is an important step in this regard. By assigning all the digital assets that are securities a standardized identifier will allow such assets to be tracked through the existing infrastructure and promote more widespread adoption of these types of assets.

An example method includes issuing from an entity, a unique identifier for all primary issuance and secondary transactions associated with a tokenized asset offering conducted on a certain platform. The process includes accessing data in an offering document (which can set forth that the offering is a Reg D or Reg A+ offering, for example) associated with the tokens to retrieve data elements necessary to guarantee uniqueness with respect to each token in a tokenized asset offering. These tokens are generally understood to be offered as securities. The unique identifier can be built on a 9-digit CUSIP taxonomy that is ubiquitous in equity and fixed income markets. The method includes tracking tokenized assets within investor portfolios. The method can also include assigning a unique identifier to a wallet. In this process, the system can globally track tokens as they move from wallet to wallet as they are traded. This eliminates the potential of buyers being anonymous and requires individuals participating in transactions to be attached to a specific identity, particularly when the respective wallet of a participant to a transaction is integrated or reconciled to a record-keeper such as a transfer agent or registrar.

Generally, a transfer agent manages and maintains records of who owns a corporation, mutual funds, stock or bonds or other security instruments. Typically, transfer agents can be banks or trust companies. The question of who owns shares after trades lies with the transfer agent. The transfer engine primarily performs three tasks. First, the transfer agent issues and cancels stock certificates, such as when companies pay a stock dividend or stock split. A transfer agent can act as an intermediary that makes the dividend or interest payments and sends out and keeps track of proxy materials, exchanges the company stock or bonds if the merger occurs, and tender shares when necessary and mails the company financials and other reports. The transfer agent can also deal with replacing lost, stolen or destroyed certificates. In the present disclosure, the tasks of the transfer agent are expanded into performing additional functions related to blockchain-based trading and security tokens having unique identifiers as disclosed herein.

The results of utilizing such unique identifiers can be to provide a standardized, reliable reference database which can be important to ensuring transparency and efficiency for market participants who trade in tokenized securities. Utilizing the CUSIP structure, or a modified structure relative to digital assets, enables record harmonization according to a standardized approach, regulatory reporting, price discovery, and/or any other functions that the CUSIP offers in the non-digital asset marketplaces can be applied to digital assets. Thus, the use of CUSIPs for digital assets can improve the facilitation of trading, clearing and settlement.

The use of a unique identifier in the form of a CUSIP for tokens and/or wallets, in connection with a transfer agent, enables an audit trail and comparisons for settlement on the backend. Even in the digital asset/tokenization environment, which is based on blockchain technology, the securities need to interact outside of the context of the blockchain ledger. This can include reporting requirements, post-trade activities related to pricing or regulatory requirements, and so forth. Typically, in the cryptocurrency world, none of these issues applied. However, by assigning CUSIP identifiers to securities and/or crypto currency wallets, cryptocurrency trading can be empowered to provide such features, which previously were not available. The technical improvement disclosed herein is the addition of unique CUSIP identifiers for digital assets that are traded with transactions recorded on a blockchain network to enable features and functionality by other entities, such as a transfer agent for example, previously not available to blockchain transactions. This approach enables the next generation of processes for recording ownership of securities beyond mere digitization and includes how to properly enhance the features which are available for traditional securities to blockchain-based digital assets.

### DETAILED DESCRIPTION

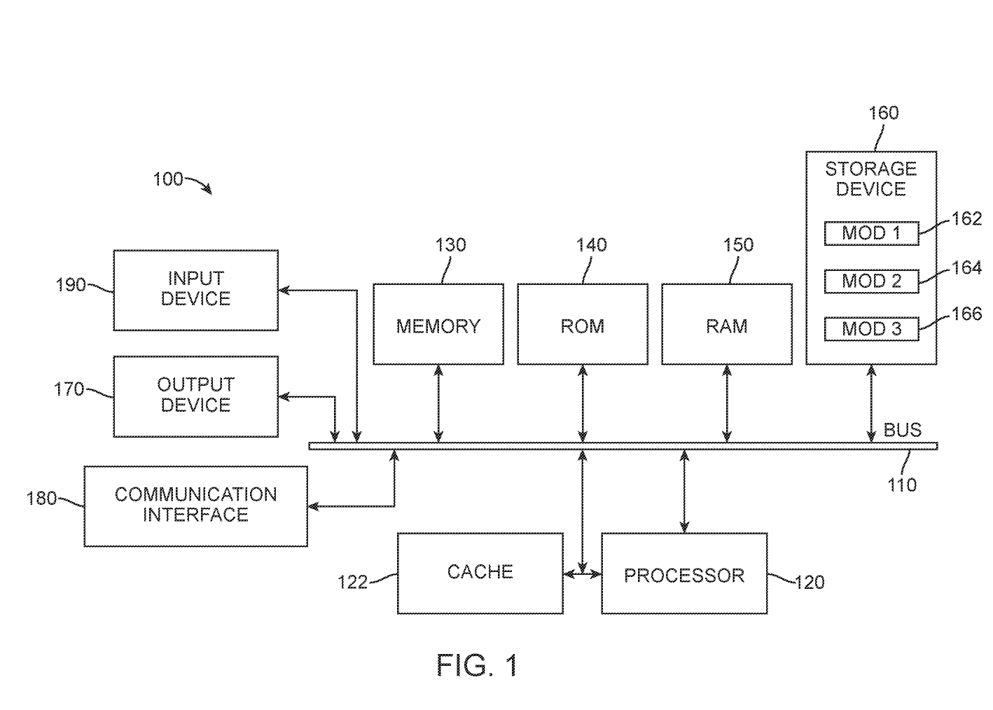

The present disclosure addresses the issues raised above. The disclosure provides several example implementations of the concepts disclosed herein. First, a general example system shall be disclosed in FIG. 1, which can provide some basic hardware components making up a server, node, or other computer system.

FIG. 1 illustrates a computing system architecture 100 wherein the components of the system are in electrical communication with each other using a connector 105. Exemplary system 100 includes a processing unit (CPU or processor) 110 and a system connector 105 that couple various system components including the system memory 115, such as read only memory (ROM) 120 and random access memory (RAM) 125, to the processor 110. The system 100 can include a cache 112 of high-speed memory connected directly with, in close proximity to, or integrated as part of the processor 110. The system 100 can copy data from the memory 115 and/or a storage device 130 to the cache 112 for quick access by the processor 110. In this way, the cache 112 can provide a performance boost that avoids processor 110 delays while waiting for data. These and other modules/services can control or be configured to control the processor 110 to perform various actions. Other system memory 115 may be available for use as well. The memory 115 can include multiple different types of memory with different performance characteristics. The processor 110 can include any general purpose processor and a hardware module or software module/service, such as MOD 1 132, MOD 2 134, and MOD 3 136 stored in the storage device 130, configured to control the processor 110 as well as a special-purpose processor where software instructions are incorporated into the actual processor design. The processor 110 may essentially be a completely self-contained computing system, containing multiple cores or processors, a bus (connector), memory controller, cache, etc. When implemented as a multi-core processor, the processor 110 may be symmetric or asymmetric.

To enable user interaction with the computing device 100, an input device 145 can represent any number of input mechanisms, such as a microphone for speech, a touch-sensitive screen for gesture or graphical input, keyboard, mouse, motion input, speech, and so forth. An output device 135 can also be one or more of a number of output mechanisms known to those of skill in the art. In some instances, multimodal systems can enable a user to provide multiple types of input to communicate with the computing device 100. A communications interface 140 can generally govern and manage the user input and system output. The system 100 is not restricted to operating on any particular hardware arrangement and therefore the basic features here may easily be substituted for improved hardware or firmware arrangements as they are developed.

The storage device 130 may be a non-volatile memory, such as a hard disk or other type of computer readable media which can store data and that is accessible by a computer. Examples of such media include, without limitation, magnetic cassettes, flash memory cards, solid state memory devices, digital versatile disks, cartridges, random access memories (RAMs) 125, read only memory (ROM) 120, and hybrids thereof.

The storage device 130 can include software modules 132, 134, 136 for controlling the processor 110. Other hardware or software modules/services are contemplated. The storage device 130 can be connected to the system connector 105. In one aspect, a hardware module that performs a particular function can include a software component stored in a computer-readable medium in connection with the necessary hardware components, such as the processor 110, connector 105, display 135, and so forth, to carry out the function.

The hardware components described above can be implemented locally for an entity performing the functions disclosed herein or could be implemented in a cloud-based infrastructure or a virtual environment. The particular computer implementation of the tokens and smart contracts described herein can be on any underlying platform.

Having introduced the basic system embodiment in FIG. 1, the disclosure turns to the other figures. Disclosed herein is a unique design for token offerings that provides clarity to investors as to what they are purchasing and includes embedded economic interests with tokens issued by an issuing entity such as a company. The token offerings are tied to and/or aligned with the issuing entity, fiduciary obligations and investor protections are provided in that the tokens fall under the regulatory structure for securities. The fiduciary obligations and investor protections are largely absent in the current marketplace. The tokens will initially embed at least one feature that will interact with a smart contract or be provided as policy data to a smart contract and can be customized and adjusted based on the issuer's desire which can lead to a blending and toggling of the variables that are embedded within the token. The initial group features that are customizable and adjustable include one or more of a unique identifier, a yield, a profit participation or revenue share, an equity position, a reward and/or a perk based incentive. Other features embedded within the token can be personalization data about the token holder (age, income, risk tolerance, job, hobbies, social media data, purchasing habits, financial history, etc.). The following disclosure will cover various aspects of these features and how the tokens operate in connection with the smart contract to implement the features associated with the unique identifier, yield, revenue share, profit participation, equity, perk based incentives, and/or other value added components

The present disclosure can also apply where a token is a cryptocurrency. This, the principles could apply to Bitcoin, Ethereum, Ripple (XRP) or any other cryptocurrency. It is also noted that in some cases the cryptocurrency may not be blockchain based. Typically, these currencies like Ripple rely on a common shared ledger, which is a distributed database storing information about the accounts and transactions. The network can be managed by a network of independent validating servers that constantly compare their transaction records. The network confirms financial transactions via a network of distributed servers. In some cases, a new ledger is created every few seconds, and the last closed ledger is a perfect record of all accounts as determined by the network of servers. A transaction is any proposed change to the ledger and can be introduced by any server to the network. The servers attempt to come to consensus about a set of transactions to apply to the ledger, creating a new ledger.

The consensus process is distributed and the goal of consensus is for each server to apply the same set of transactions to the current ledger. Servers continually receive transactions from other servers on the network, and each respective server determines which transactions to apply based on if a transaction came from a specified node in the ‘unique node list’ (UNL).

Transactions that are agreed upon by a majority or supermajority of peers are considered validated. If the supermajority isn't in consensus, it would imply that transaction volume was too high or network latency too great for the consensus process to produce consistent proposals. In that case, the consensus process is again attempted by the nodes. Each round of consensus reduces disagreement, until the supermajority is reached. The intended outcome of this process is that disputed transactions are discarded from proposals while widely accepted transactions are included.

Smart contracts are operable in blockchain networks and help to exchange money, property, shares, or anything of value in a transparent, conflict-free way while avoiding the services of a middleman. Smart contracts can be compared in terms of technology to a vending machine. Ordinarily, a client would go to a lawyer or a notary, pay them, and wait while someone retrieves a requested document. With smart contracts, the user simply drops a bitcoin into the vending machine (i.e. ledger), and the escrow, driver's license, or other item drops into their account. More so, smart contracts not only define the rules and penalties around an agreement in the same way that a traditional contract does, but also automatically enforce those obligations. For example, an option contract between parties can be written as code into the blockchain. Individuals involved in the agreement can be anonymous but the contract is the public ledger. A triggering event, such as an expiration date or a strike price being reached, may occur and the contract will automatically execute itself according to the coded terms. Regulators can use the blockchain to understand the activity in the market while at the same time maintaining the privacy of the individual actor's positions.

The following is an example of a smart contract in operation. Suppose Fred rents an apartment from Sam. The parties can do this through the blockchain by paying in cryptocurrency. Fred gets a receipt which is held in the virtual contract. Sam gives Fred the digital entry key which comes to Fred by a specified date. If the key does not come on time, the blockchain releases a refund. If Sam sends the key before the rental date, the function holds it releasing both the fee and key to Sam and Fred, respectively, when the date arrives. The system works on the “If-Then” premise and is witnessed by hundreds of people, so one can expect a faultless delivery. If Sam gives Fred the key, Sam is sure to be paid. If Fred sends a certain amount in bitcoins, Fred receives the key. The document is automatically canceled after the time, and the code cannot be interfered with by either of Sam or Fred without the other knowing since all participants are simultaneously alerted. People can use smart contracts for all sorts of situations including, without limitation, financial derivatives, insurance premiums, breach contracts, property law, credit enforcement, financial services, legal processes and crowdfunding agreements.

Bitcoin was essentially the first cryptocurrency to support basic smart contracts in the sense that the network can transfer value from one person to another. The network of nodes will only validate transactions if certain conditions are met. While Bitcoin is limited to the currency use case, Ethereum is different from Bitcoin's more restrictive language (a scripting language of a hundred or so scripts) and replaces it with a language that allows developers to write their own programs. Ethereum allows developers to program their own smart contracts, or “autonomous agents”. The language is ‘Turing-complete”, meaning it supports a broader set of computational instructions. Smart contracts can function as “multi-signature” accounts, so that funds are spent or actions may occur only when a required percentage of people agree, manage agreements between users, say, if one buys insurance from the other, provide utility to other contracts (similar to how a software library works) and/or store information about an application, such as domain registration information or membership records.

Smart contracts are likely to need assistance from other smart contracts. When someone places a simple bet on the temperature on a hot summer day, for example, it might trigger a sequence of contracts that are related. One contract would use outside data to determine the weather, and another contract could settle the bet based on the information it received from the first contract when the conditions are met. Running each contract requires Ether transactions fees, which depend on the amount of computational power required. Ethereum runs smart contract code when a user or another contract sends it a message with enough transaction fees. The Ethereum Virtual Machine then executes smart contracts in “bytecode”, or a series of ones and zeroes that can be read and interpreted by the network. While Ethereum is mentioned, any blockchain-based platform can be used to host the smart contracts disclosed herein.

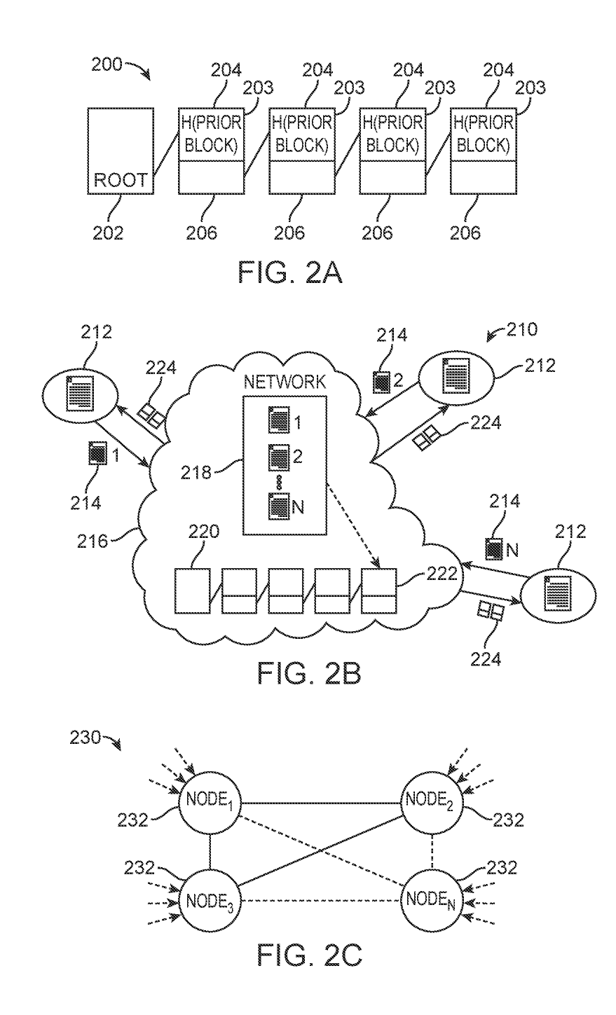

FIGS. 2A-C depict a typical blockchain network. In particular, FIG. 2A illustrates a blockchain data structure 200 made up of a sequence of linked block data structures. A root block 202 typically forms the basis, sometimes referred to as a genesis block, for a blockchain data structure 200. In some aspects, the root block 202 can be a completely self-sufficient seed for an entirely new blockchain data structure 200. For example, the root block 202 of the Bitcoin blockchain does not reference a preceding block and is the original seed from which the Bitcoin blockchain eventually grew. In some other aspects, the root block 202 may be constructed on top of another, already existing blockchain network (e.g., Ethereum, etc.) as a token in order to leverage an existing environment or other features of the underlying network.

The root block 202 typically includes contextual information, but can also include other useful information for downstream blocks 203 or participants and/or observers of the blockchain data structure 200 such as license information, policy guidelines, mission statements, and the like. The blocks 203 may typically be cryptographically linked, directly and indirectly, to the root block 202 via respective headers 204 which each contain a hash of the preceding block 203 or root block 202, as appropriate.

A hash refers to the output of an algorithm which may produce a unique, consistent value based on an input with relatively low risk of collision (e.g., two inputs producing the same output). For example, and without imputing limitation, using the common SHA-256 hashing algorithm on the phrase “genesis node” produces the value: 7856FF57093221558352BDF4D55531D4FCD72BF7CC8BFFBB86E527606A453B9E.

Where the hash is of the preceding block 203 (as compared to where the root block 202 is the preceding block), the respective hash will include the hash contained in the preceding header 204 of the preceding block 203. While cryptography is more widely known for obfuscating data, in the context of a blockchain, a cryptographic hash is used to validate the veracity of the contents of the previous block based on the low risk of collision and the straightforward reproducibility of attempting to reproduce the hash. In other words, any given block can be checked for alteration by simply producing a hash of it and comparing that hash with the hash stored by the block following it. For example, the hash generated above will always be produced from the phrase “genesis node.” However, should the phrase “node genesis” be hashed instead, the hash value will be: E4AFE39853B29E37A44648B9BF376801DCF90302CD894BD04170F919F979479F. Thus, it is merely a matter of reproducing a hash of the contents and comparing against the later recorded hash to verify the authenticity of contents 206 of a block.

The contents 206 of the blocks 203 in a blockchain 200 may contain virtually any type of data. However, as depicted by FIG. 2B, programmable data records, such as one or more smart contracts 214, can be stored as the block content 206. For example, a network 216 may construct a new block 218 containing N, or an arbitrary number of, smart contracts 214. The smart contracts 214 typically represent an automated agreement 212 constructed off-network before being provided to the network 216 for recordation and execution. In response, the network 216 can provide a return portion 224 of an updated blockchain 220 including an appended block 222 (which corresponds to the new block 218).

Typically, the network 218 can be a node network 230, as depicted by FIG. 2C. The node network 230 itself may include a multitude of nodes 232 which are responsible for maintaining and authenticating the blockchain 200 by receiving material for updates (such as automated contracts 212) from users. In some aspects, the nodes 232 may require consensus between all N nodes, or a majority of nodes, to validate a new block 218 before an updated blockchain portion 224 may be distributed back to users. In some embodiments, nodes 232 may engage in a race to update the blockchain such as by producing a proof of work such as, for example, solving a puzzle that is difficult to solve but easy to verify (for example, by determining a value which produces a hash of the intended new block having specified characteristics, such as a particular number of leading 0s). In some examples, a proof of stake or other proof may be required for a node 232 to update the blockchain 200. In yet other examples, the nodes 232 may perform the process of executing any programmatic contents of the new block 218, such as when the new block contains a smart contract.

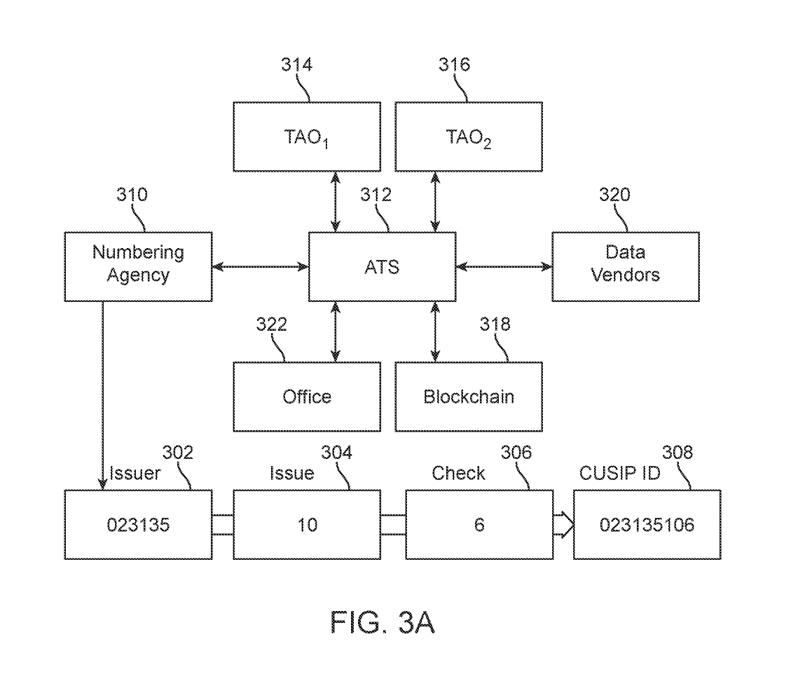

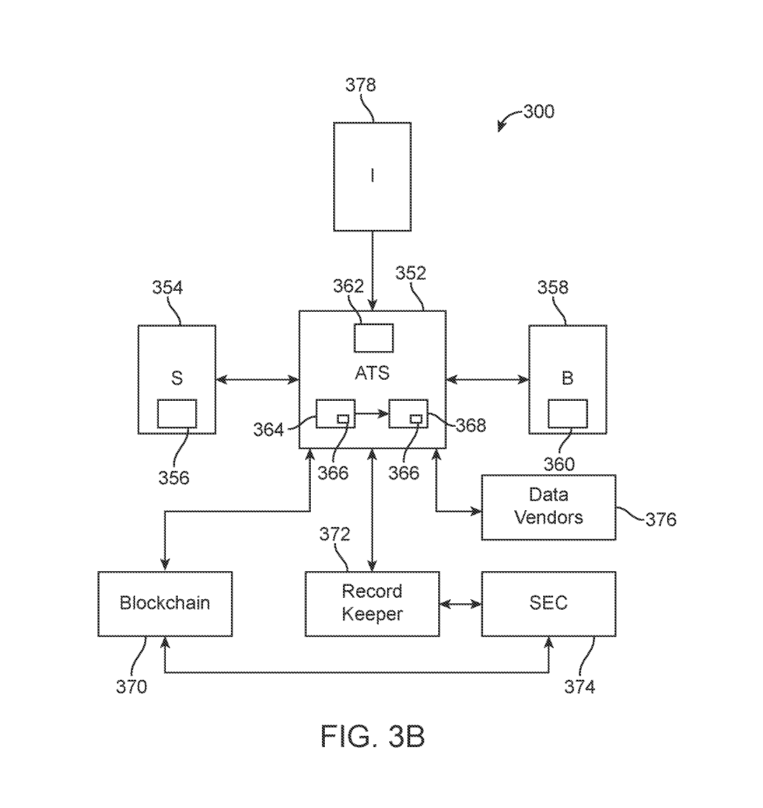

The present disclosure includes a number of features around the addition of unique identifiers to security blockchain-based tokens and wallets and the additional functionality and capabilities that flow from that data. FIG. 3A illustrates an example CUSIP identifier 300. A CUSIP identifier 300 it is a nine character identifier that captures and issues important differentiating characteristics with a common protocol or structure. Is typically used as an identifier for issuers and their financial instruments offered in the United States and Canada. The CUSIP number identifies most financial instruments such as stocks of all registered US and Canadian companies, per commercial paper, US government and municipal bonds. The structure includes a first number 302 related to the issuer. This typically represents the first 6 characters of the identifier. These first six characters identify the unique name of the company, municipality, government agency, or other entity. Applied to digital assets, it would uniquely identify the name of the issuer to the tokens or the distributed autonomous organization. The next two characters 304 identify the type of instrument and/or can identify the specific token or group of tokens. Typically, it identifies the instrument as an equity instrument or a debt instrument. With respect to digital assets, these characters can also represent other types of digital assets beyond equity or debt related tokens. The data 304 is the data field which can identify each respective token that is part of a tokenized asset offering. The next character 306 is a mathematical formula check of the accuracy of the previous 8 characters. It can deliver a single character check result. The resulting identifier 308 includes 9 characters and can be a unique identifier for a financial instrument or security token or digital asset. A CUSIP can also include an international numbering system where the same structure as described above can be provided, but a letter of the alphabet can be used in the first position to identify an issuer's country or geographic region.

In another aspect, the structure of the CUSIP can also include a country code, a local identifier and the check to result in a 12 character code that can be a global uniform unique code that identifies instruments to facilitate cross-border trading. These CUSIP identifiers have never been applied or issued uniquely for primary issuance and secondary transactions known as tokenized asset offerings.

The CUSIP identifier can increase standardization across the securities industry for blockchain-based securities as well as non-blockchain-based securities, and help to streamline the communication between issuers and potential investors. The identifiers allow computer systems to independent financial firms, market data vendors, and trading platforms to track various securities through the entire supply chain. The process can facilitate simple archiving of transaction flow as well as auditability. One way. This can be accomplished is through a programmed smart contract that, when managing a transaction associated with the security token, can detect or recognize the unique identifier associated with one or more of a security token or tokens and/or a cryptocurrency wallet associated with the buyer or seller, and initiate a reporting process to provide data associated with the transaction to a record-keeping entity.

The present disclosure introduces a new technical application of CUSIP numbers that apply to tokenized asset offerings (TAOs) that are based on the blockchain but that are also issued is securities in the thus have the appropriate documentation associated with proper securities. A blockchain-based alternative trading system (ATS) 312 can have various entities that provide TAOs 314, 316 for trading on the platform 312. To provide and promote liquidity and post trade operational efficiency for TAOs in ways not previously possible, the ATS 312 can establish communication between its system and a numbering agency 310, such as the CUSIP Global Services (CGS). The numbering agency 310 can receive documentation or data associated with each respective TAO for tokens to be traded on the ATS platform 312. FIG. 3A illustrates the data coming from the ATS 312 but the respective issuers 314, 316 could also contact the numbering agency 310 directly. The numbering agency 310 can provide a graphical user interface accessible by issuing entities 314, 316 to provide the issuing documentation from which the numbering agency can generate CUSIP numbers. The numbering agency 310 will extract from the issuing documentation certain data and issue CUSIPs, or nine-digit alphanumeric codes (or codes of a different configuration), to entities associated with the TAOs traded on the alternative trading system 312. The ATS 312 is a broker-dealer registered with the US Securities and Exchange Commission and through this process can offer CUSIP identifiers to TAOs 314, 316 trading on its platform. Popular with real estate firms, TAOs represent a recent incarnation of initial coin offerings (ICOs). ICOs allowed firms to raise capital through a global investor base yet often violated US securities laws. Instead, TAOs are variations on private placement securities following the same SEC rules as securities. TAOs are represented as tokens whose ownership is reflected on a public blockchain ledger 318 using smart contracts. The smart contracts specify the terms and conditions, such as the price, time of offering and type of security being sold similar to the offering document for a private placement.

The alternative trading system 312 allows buyers and sellers to place indications of interest for TAOs which can then be matched. Having an identification number 308 ensures that buyers and sellers can verify exactly which TAO they are buying and selling and the execution price. Because the TAOs now according to this disclosure have CUSIPs, bid and offer prices can also be found through data vendors such as Bloomberg and Reuters 320. Communication of bid and offer prices for respective TAOs can be provided to the data vendors 320 from the ATS 312. As noted above, a smart contract is operating on the trading platform 312 can identify or recognize unique identifiers associated with security tokens which can trigger a communication to a data vendor 320 to transmit data associated with the respective token. Middle or back office systems 322 also benefit from the CUSIP ID codes as they can accurately record the transactions, thereby eliminating the potential for settlement errors or incorrect payments.

For issuers 314, 316, getting a CUSIP for a tokenized asset is just as simple as one for stocks and bonds. All the issuer 314, 316 has to do is fill out the proper documentation with numbering agency 310 and it will be assigned one after a numbering agent analyst extracts up to 60 discrete data elements to determine the uniqueness of the TAO. So far, CGS has issued over 40 million CUSIPs to a wide range of US stocks and bonds, including alternative assets such as syndicated loans. The first six characters of a CUSIP for a TAO identify an individual issuer, the next two characters identify the type of issue, the order in which it was issued and can be used to uniquely identify a respective security token. The final digit is the check digit.

FIG. 3B illustrates another aspect of using unique identifiers for tokens and/or wallets. A system 350 includes a number of different components. An alternative trading system 352 is a cryptocurrency or trading platform that enables tokens that are identified as securities to be traded. A smart contract 362 can operate on this platform, or in connection with this platform on a blockchain network 370 to perform some the functionality disclosed herein. A seller has a computing device or seller wallet 354 which stores data associated with the tokens owned by that seller. The unique identifier 356 can be associated with the individual's wallet 354. The wallet unique identifier can include fields for identifying the individual, a geographic location of the individual, an accredited nature of the individual, and address of the individual, other identification means associated with the individual, and so forth. Assume that the seller 354 desires to sell the token 364 on the alternative trading system 352. The token 364 includes the unique identifier 366. A buyer having a buyer wallet 358 desires to purchase, via the alternative trading system 352, the token 364. A database can be accessed which can enable the buyer 358 to receive the CUSIP identifier for the token 364. The buyer can access a data vendor 376, the alternative trading system 352, the blockchain 370, a record-keeping entity, or any other entity that can store data about the tokens accessible via the unique identifier. It is noted that the wallet 358 associated with the buyer can also include a unique identifier 360. The data that can be accessed can be offering materials, any updates regarding the offering, company information, news, or any other data that is typically available for non-digital assets or standard securities. Having a separate listing (for example, in a record-keeping entity separate from a blockchain network) of each token associated with a tokenized asset offering as well as data associated with all of the buyers of that token can enable a company to communicate with all the shareholders in ways not previously possible for crypto currencies.

In one aspect, data about the issuer 378 is stored on the blockchain network 370. Thus, news about the issuer 378, such as a newsletter, a press release, a required filing with the SEC, financial updates, right or any other news can be hashed back to the blockchain 370, via a smart contract operating on the blockchain 370 utilizing the unique identifier or data from the CUSIP construct that identifies the issuer. In this regard, individuals who provide a unique identifier associated with one of the tokens offered by the issuer or that identifies the issuer itself can retrieve the same data available to all.

While the issuer 378 is shown as communicating with the alternate trading system 352, the issuer 378 may also be connected directly with the blockchain network 370 which can have a smart contract operating thereon. In one aspect, the issuer can have a computing system with a data reporting module which operates to take any relevant information, such as newsletters, press releases, financial updates, and so forth and generate a hash that is technically tied to the unique identifier information associated with the identifiers of the tokens issued by the issuer. The hashed data is transmitted to a smart contract associated with the blockchain 370 for recordation on the blockchain 370 in connection with that issuer. In this automated fashion, data about the issuer can be recorded and accessible through the use or entry of an identifier associated with the issuer by individuals desiring to learn more about the issuer and determine a value of tokens issued by the issuer 378. In one aspect, a user might have the CUSIP identification data which includes issuer data, data, identifying the issued instrument, the check data, and so forth, and by entering in the CUSIP identification data for a token, the issuer data (press releases, financial updates, etc.) can be retrieved from the blockchain. This operation can be managed by a smart contract which also includes the capability of providing user interface for users to enter the data associated with the token identification, and then retrieve or access the data from the blockchain.

Assume that the buyer 358 on the exchange 352 purchases the token 364 to yield a purchased token 368 which contains or has embedded within it the unique identifier 366. Data regarding that exchange can be recorded on the blockchain 370. In another instance, data associated with the exchange can be provided to a record-keeper 372 which can be registered with the securities exchange commission 374. The triggering of the communication of transaction data to the record-keeper 372 can be caused by a smart contract managing a trade which can detect to identify the unique identifier associated with the token or tokens in a trade in which can cause the smart contract to retrieve the transaction information including the unique identifier and transmitted to the record-keeper 372.

Data can also be provided to the blockchain 370 and/or to a data vendor 376. The data provided to these various entities can be based on the CUSIP identifier associated with the tokens. Data regarding the seller's identification as well as the buyers identification can be drawn from the unique identifier associated with each respective wallet 356, 360. Part of the reconciliation process operated by the smart contract 362 can involve an integration of a transfer agent 372 and the wallets 354, 358 such that information provided regarding the trade, the previous owner, the new owner, and the unique identifiers associated with each of those tokens and entities can add investor protection into the overall system. These digital assets that operate as securities can thereby be monitored and recorded with a transfer agent 372, which is a registered entity with the SEC 374.

One of the benefits introduced by the technical addition of a CUSIP unique identifier associated with the token is that the transfer agent 372 can be considered to be a qualified custodian. In a sense of the digital asset. In one aspect, the transfer agent 372 does not literally store or act as the custodian of the respective digital asset, but the utilization of unique identifiers that can be attached to tokens and/or wallets enables the movement of these tokens from a seller to a buyer to no longer be anonymous but rather enables that transition to be attached to a specific identity, particularly with respect to the unique identifier integrated into the seller and buyer wallets.

The unique identifier 356, 360 can have a different structure than the CUSIP structure shown in FIG. 3A. For example, a first field can identify the individual or entity who owns or controls the wallet. Other fields can include information such as contact information, an address, a characterization of the individual with respect to their accredited status as defined by the Securities and Exchange Commission, or other government entity, and so forth. When participating in the exchange with the alternate trading system 352, a protocol can be included in which the identification of the respective buyer and seller through their unique identifiers associated with their wallets, or associated with a device related to each respective participant in the trade, can be communicated to the alternative trading system 352. The unique identifier 366 associate with the token itself is of course also available to the platform 352. When the trade occurs, the various identifications of the seller, the buyer, and the individual token can be provided to the transfer agent 372 which can enable an audit trail to be possible.

One benefit of this approach is that it addresses a pain point in the settlement process of buying and selling digital assets, in which there might be some question regarding the exact asset which is being purchased. Using the unique identifiers, a higher level of confidence exists that the right asset is being exchanged. This surety reduces the complexity in the settlement and clearance function.

The SEC 374 can also represent regulators or auditors who desire to review transactions to ensure that they were fair and transparent. Having a record-keeper 372 that is registered with the SEC 374 enables a window into the history of transactions that was previously unavailable to regulators.

In another aspect, the data associated with the unique identifier is recorded on the blockchain 370 in connection with the recordation of the transaction of the sale of the token 364 from the seller to the purchase token 368, from the buyer 358. Thus, the audit information associated with the transaction can be recorded in the blockchain and made available for review or access by an auditor 374. Regulators are able to see volumes of trades, parent orders to child orders, concentrations of purchasing from certain areas, individuals or geographic regions. Machine learning algorithms can be trained and deployed to learn about patterns of trading Blockchain-based security tokens through the use of these unique identifiers. Trained machine learning models can then be deployed to assess trading patterns of blockchain-based security tokens to look for anomalies which can indicate fraud or nefarious activity.

Front running of securities is a prohibited practice of entering into an equity or stock trade, options, futures contract, derivative or security-based swap to capitalize on advance, nonpublic knowledge of a large pending transaction that will influence the price of the underlying security. Utilizing the unique identifiers as disclosed herein can enable an auditor 374 or machine learning model to detect in a record-keeper's data 372, or a blockchain record 370 whether front running activity has occurred in connection with a token. Issues with respect to insider trading can also be detected via an auditor utilizing the records that are established as described herein. The record keeper can also be considered a transfer agent 372.

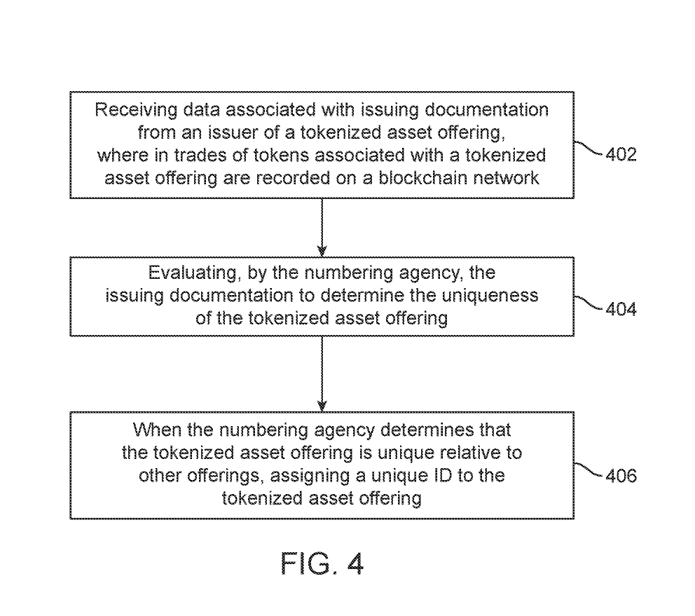

FIG. 4 illustrates a method example from the standpoint of the numbering agency 310. The method includes receiving data associated with issuing documentation from an issuer of a tokenized asset offering, wherein trades of tokens associated with a tokenized asset offering are recorded on a blockchain network (402), and evaluating, by the numbering agency 310, the issuing documentation to determine the uniqueness of the tokenized asset offering (404). When the numbering agency 310 determines that the tokenized asset offering is unique relative to other offerings, assigning a unique ID to the tokenized asset offering (406). The numbering agency 310 can perform these processes via a computerized system and a graphical user interface that is made available over a network to issuer devices for providing the issuing documentation. The numbering agency 310 can automatically extract discrete data elements from the documentation and compare those data elements to other documentation associated with other offerings, to arrive at a determination that the requesting issuer of the tokenized asset offering is proposing a unique tokenized asset offering and should receive the unique ID.

In one aspect, while CUSIP identifiers have been used for traditional stocks and bonds, the configuration of the identifier for tokenized asset offerings can be modified. For example, a separate character could be added to the protocol to identify that the asset is a blockchain-based token. Data could be used to identify the nature of the blockchain network associated with the tokenized asset offering, such as whether it is a public blockchain or a private blockchain.

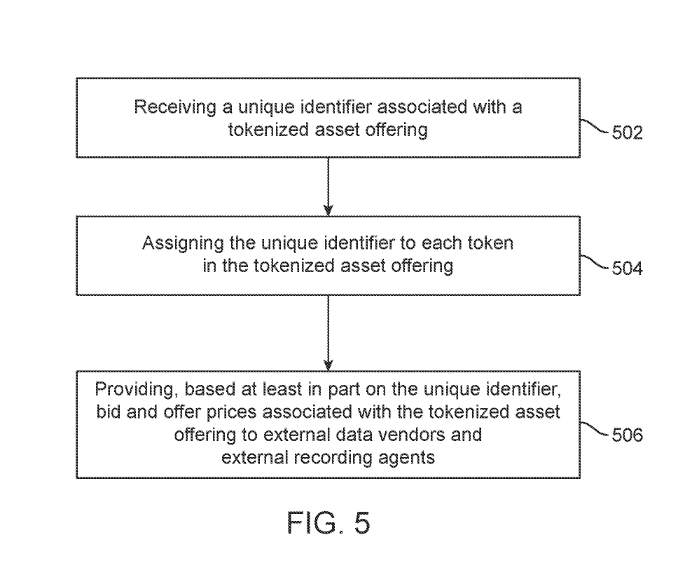

FIG. 5 illustrates an example method from the standpoint of the ATS 312 with respect to the use of CUSIP identifiers for tokenized asset offerings. The method includes receiving a unique identifier associated with a tokenized asset offering (502), assigning the unique identifier to each token in the tokenized asset offering (504), providing, based at least in part on the unique identifier, bid and offer prices associated with the tokenized asset offering to external data vendors and external recording agents (506).

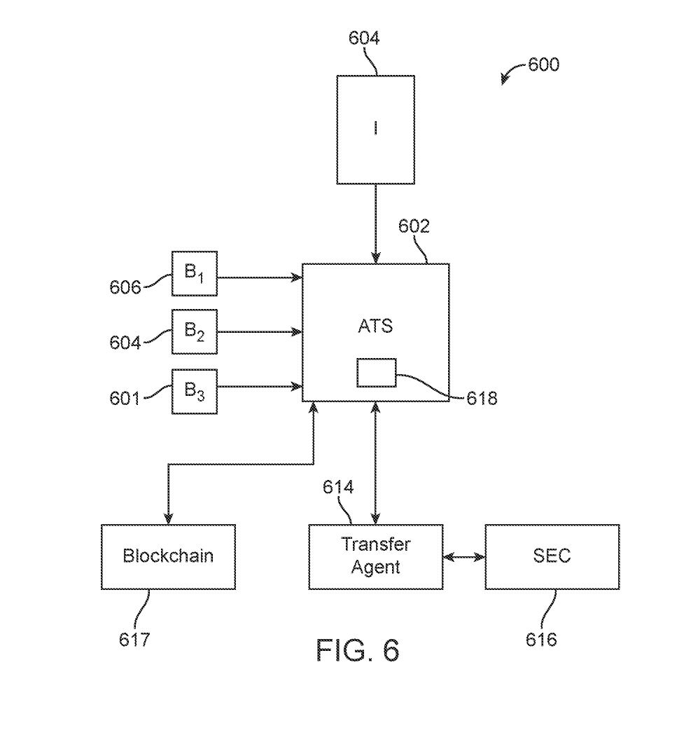

FIG. 6 illustrates another aspect of this disclosure, which relates to who the holder of record is with respect to security tokens. Section 12(g) of the Securities Exchange Act establishes the thresholds at which an issuer is required to register a class of securities with the Securities and Exchange Commission. For example, an issuer that is a bank, a bank holding company or savings and loan holding company is required to register a class of equity securities, if it has more than $10M of total assets and the securities are “held of record” by 2,000 or more persons. Where the issuer is not a bank, bank holding company or savings-and-loan holding company, it is required to register a class of equity securities if it has more than $10M in total assets and the securities are held of record by either 2,000 persons, or 500 persons were not accredited investors. Upon meeting these thresholds, the issuer has to comply with reporting within a certain amount of time, say 12 months. These are several example regulations which can apply, although other regulations and other thresholds of course may apply. The question is how does this apply or how is this enforceable in the context of tokenized asset offerings and blockchain-based security tokens.

There are number of different attributes of an initial offering that can require remediation. For example, some attributes can include the fact that there were fewer than 2,000 holders of record or that most holders of record meet the requirements of accredited investor status. The offering may have been conducted on or off shore. To address any one or more of these attributes of the initial offering, the system may implement a process for remediation which can include one or more of creating a new company, providing all accredited investors with the option to receive rescission or to receive equity and the new company, providing a rescission to all unaccredited investors and/or conducting an exempt offering of equity in the new company under Regulation D.

In another example, the attributes of an initial offering might include that the holders of record were a mix of accredited and unaccredited investors or the total amount of funds raised was under $50M. The possible process from remediation can include one or more of retroactively filing a form 1-A to remediate the improper offering. By taking this step, all original investors will have their equity or debt converted into equity or debt under Regulation A. Remediation can also include that the investors will be provided the option to participate in the regulation A conversion. If they don't desire to participate, they will be provided their money back.

In another example, the attributes of an initial offering might include that there were more than 2,000 holders of record in the offering raised over $50M. The process for remediation can include one or more of determining if the initial token issuance took place only to accredited investors, for example through a sample agreement for future tokens (“SAFT”), then, the issuer will file a remedial form D. All original investors will have their interests converted to equity or debt under the new filing or will be provided with rescission if they so choose. Otherwise, the remedy could be that the issuer will be required to file a form S-1 to remediate the improper offering. All original investors will have their interests converted to equity or debt under the new filing or will be provided with rescission if they so choose.

In the environment shown in FIG. 6, a system 600 includes an issuer 604, an alternative trading system 602 and a number of buyers of tokens 606, 608, 610. The alternative trading system can include a smart contract 618 and it can operate on a blockchain network 617.

A mechanism is disclosed herein which enables issuer's 604 to comply with their affirmative obligation under Rule 12(g). Under the previous mechanisms of an issuer providing a tokenized asset offering on the blockchain, the issuer has no way of knowing the exact number of shareholders they have. The blockchain by nature is decentralized and without a mechanism of reporting to the issuer the number of shareholders. Furthermore, the approach did not necessarily give consideration of all of the assets associated with an issuer 604 or those assets were difficult to value. Thus, one solution disclosed herein is to provide in the context of the blockchain and decentralized ledgers a mechanism to compliantly certify the shareholder headcount. The approach involves implementing a smart contract 618 that can reconcile to a transfer agent 614 in order to have a real time accurate count of shareholders 606, 608, 610, in order to comply with Rule 12 (g). By utilizing the unique identifiers in which each token has its own unique identifier by virtue of the issued instrument field 304, and by utilizing the unique identifier for each user wallet 356, 360, the alternative trading system 602 operating a smart contract can report or reconcile trades to the transfer agent 614 and maintain a real time accurate count of shareholders. The transfer agent 614 is registered with the SEC 616. Under SEC rules, some entities can be self regulatory organizations (SROs). This process can give the SRO visibility into the transactions in real time. An important point of this mechanism is to ensure that the smart contracts or the tokens associated with them 618 are not bearer instruments as the transfer agent 614 and not the blockchain 617 can be considered the ultimate arbiter of ownership via its certified records. Tying the smart contract of the issuer back to the transfer agent 614 can enable the issuer to receive real-time an indication data regarding the number shareholders and thus enable compliance with Rule 12(g). In another aspect, utilizing the unique identifiers as disclosed herein enables the issuer to also specifically know who the shareholders are. Previously, the issuer did not have this specific understanding of who had purchased tokens in the tokenized asset offering.

The identification of shareholders to an issuer in a blockchain-based tokenized asset offering enables valuable functionality. The technology disclosed herein enables new one to one correspondence between the issuer and its shareholders. For example, newsletters, financial updates, and so forth can be provided to shareholders in a manner not previously possible for blockchain-based token shareholders. To make this possible, the unique identifier associated with the wallet can include communication information such as an email address, a cell phone address for texting, a brick-and-mortar address, and so forth. The data can also include social media contact information such as Facebook information, Twitter information, Instagram information or Facebook Messenger information, and so forth. Thus, an issuer could receive from a transfer agent a listing of its shareholders and contact information associated with each shareholder and could communicate information to those shareholders in new ways. A trading platform could also communicate with parties that have performed trades.

Other granulated information could also be extracted from the record-keeper 372. For example, an issuer could provide a communication to all parties who traded their tokens in the last six months or to all parties in Canada who traded the tokens. Other monetizing activity can be initiated such as advertisements to targeted groups of traders as identified by the record-keeper 372.

By virtue of this implemented system, if a wallet associated with the buyer 606, 608, 610 is hacked and security tokens are stolen, the wallet itself or the smart contract 618 are not considered bearer instruments and the transfer agent 614 can stop or cancel the hacked instrument and cause a replacement instrument to be generated for the beneficial owner. One benefit of this approach is that it would greatly reduce or eliminate the incentive to hack securities wallets as a hacker would end up with a worthless instrument with no economic value. Typically, hacking crypto currency wallets can be done anonymously such that the individual hacked may have no recourse or mechanism to identify the hacker and retrieve their value.

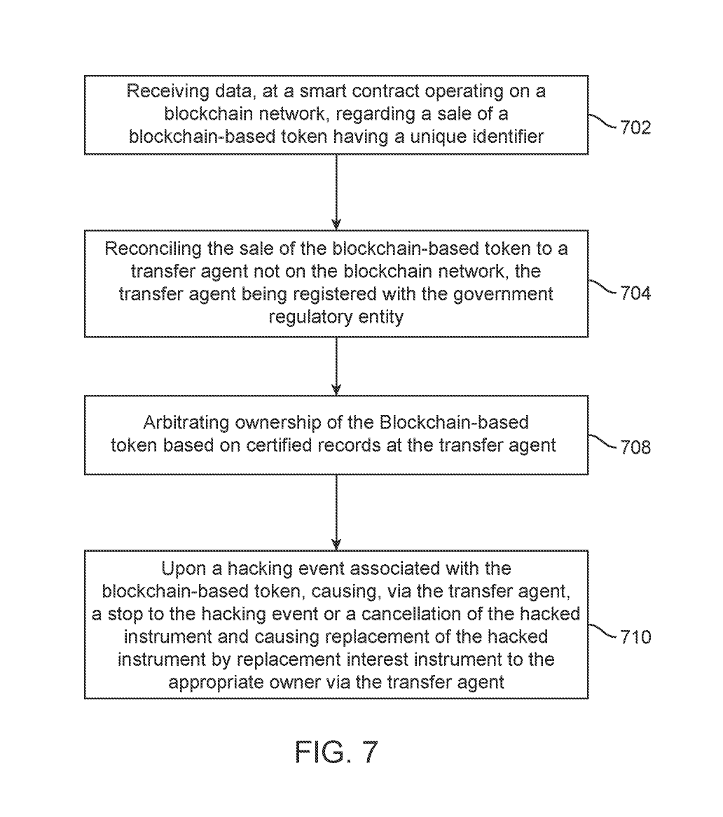

FIG. 7 illustrates an example method approach with respect to providing real time monitoring of blockchain-based security token transactions off a blockchain network. The method includes receiving data, at a smart contract operating on a blockchain network, regarding a sale of a blockchain-based token having a unique identifier (702), reconciling the sale of the blockchain-based token to a transfer agent not on the blockchain network, the transfer agent being registered with the government regulatory entity (704), and arbitrating ownership of the blockchain-based token based on certified records at the transfer agent (708). The method includes, upon a hacking event associated with the blockchain-based token, causing, via the transfer agent, a stop to the hacking event or a cancellation of the hacked instrument and causing replacement of the hacked instrument by replacement interest instrument to the appropriate owner via the transfer agent (710). The transfer agent can send instructions to a smart contract to carry out the stop action, cancellation action, and replacement action, which can perform required action and cause the appropriate recordation to occur on the blockchain.

It is noted that the approach set forth above, ensures that the smart contract is not a bearer instruments associated with the token and that the transfer agent is the ultimate arbiter of ownership based on its certified records. In one aspect, where the blockchain 617 is a public blockchain, the data that can be drawn from the unique identifiers can be stored at the transfer agent 614 in a more private manner such that the data is not public. However, that data can then be available for auditors or for addressing hacking.

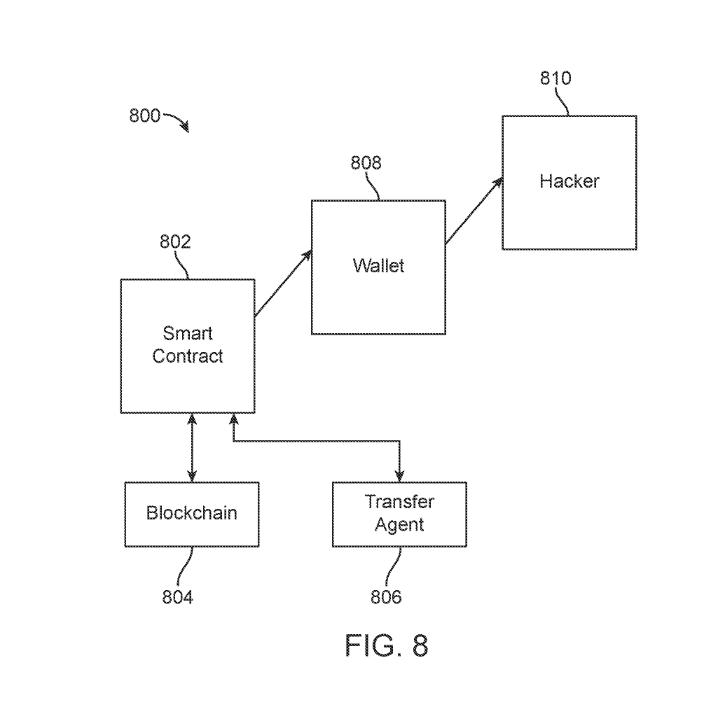

FIG. 8 illustrates the basic components that apply to using the transfer agent to address hacking concerns. The components 800 can include a smart contract which can be part of an alternate trading system or can be some other entity managing this process. In the process disclosed herein, using the unique IDs associated with tokens, users, user wallets, and be used for tracking the parties, the parent orders, the baby orders, who bought tokens, who sold tokens, and so forth. The transfer agent 806 registered with the SEC can maintain basically a backup copy of records stored on the blockchain 804 to enable a policing mechanism to identify and correct for innocent token holders 808 who have their wallets hacked by a hacker 810.

Creating redundancy of the records on the blockchain 804 in the transfer agent 806 accomplishes a number of different tasks. First, if the hacker 810 hacked into the wallet 808 and steals the tokens contained within that wallet, because those tokens have associated unique identifiers, they can be tracked. Based on certified records in the transfer agent 806, the system knows who the beneficial owner is in real time of each respective token. Between the smart contract 802, the CUSIP identifier tracking and the transfer agent 806, the system can identify that the owner of the wallet 808 was the last bona fide purchaser of that token and that they no longer have that token in their wallet. The transfer agent 806 can now provide an instruction to the smart contract 802 to put a stop order or cancellation order associated with that token or tokens which can prevent the hacker 810 from selling those tokens on alternative trading system 802. The transfer agent 806 could also instruct the smart contract to record on blockchain 804 a destruction or deletion of the stolen token or tokens and to reissue new replacement tokens to the beneficial owner 808.

In one aspect, wallets with unique identifiers can be required to be able to transfer or receive a security token having a unique identifier. In other words, if the hacker wallet 810 does not have a unique identifier that can identify the individual or owner of that wallet, then the system, or smart contract that would be utilized to manage a transfer of a stolen token would prevent the security token from being transferred from the wallet 808 to the hacker wallet. This could also prevent undesired hacking by virtue of the hacker being identifiable rather than anonymous. The process in this regard could include a smart contract being required to transfer any secured token from a transferring wallet to a receiving wallet only upon confirming that the receiving wallet has an appropriate unique identifier and is not anonymous.

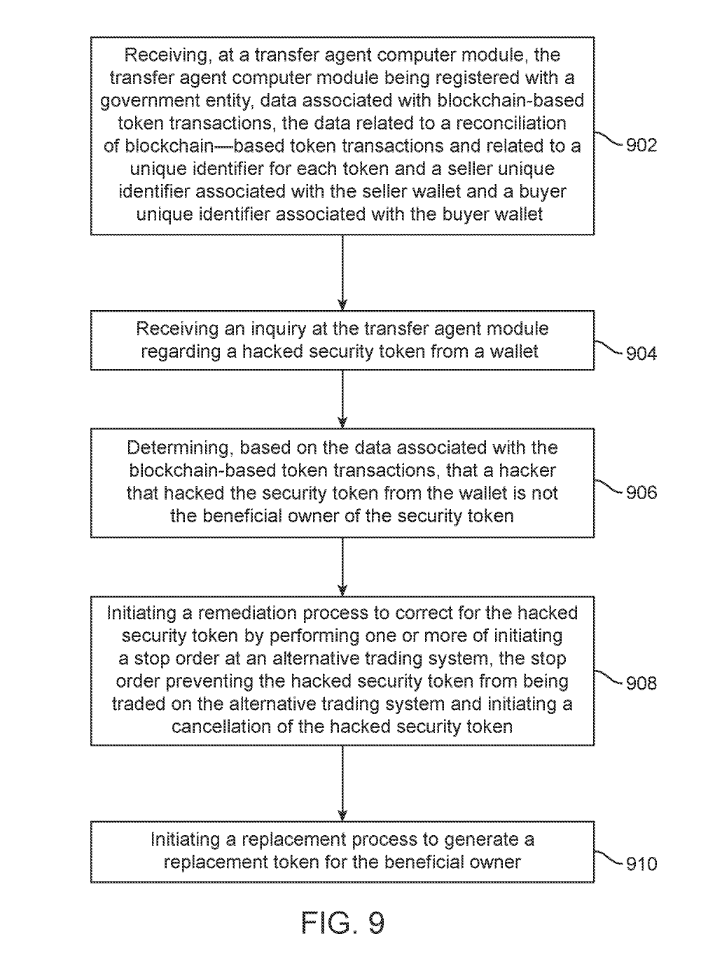

FIG. 9 illustrates an example method with respect to the operation of the transfer agent. The method in this regard includes receiving, at a transfer agent computer module, the transfer agent computer module being registered with a government entity, data associated with blockchain-based token transactions, the data related to a reconciliation of blockchain-based token transactions and related to a unique identifier for each token and a seller unique identifier associated with the seller wallet and a buyer unique identifier associated with the buyer wallet (902), receiving an inquiry at the transfer agent module regarding a hacked security token from a wallet (904), determining, based on the data associated with the blockchain-based token transactions, that a hacker that hacked the security token from the wallet is not the beneficial owner of the security token (906), initiating a remediation process to correct for the hacked security token by performing one or more of initiating a stop order at an alternative trading system, the stop order preventing the hacked security token from being traded on the alternative trading system and initiating a cancellation of the hacked security token (908), and initiating a replacement process to generate a replacement token for the beneficial owner (910). The transfer agent 806 can provide instructions that are authorized to be carried out via smart contract 802 or via the alternative trading system. The instructions can include identification of the hacked security tokens, the instructions to stop or cancel the tokens, and the necessary data regarding the identification of the beneficial owner, and a value associated with the hacked security tokens, so that the appropriate equal valued replacement remedial security tokens can be generated for the beneficial user and provided to the appropriate wallet 808.

The process as outlined above reduce cyber terrorism and anti-money laundering (AML) concerns as security tokens would no longer be a target for hackers or for illicit activity.

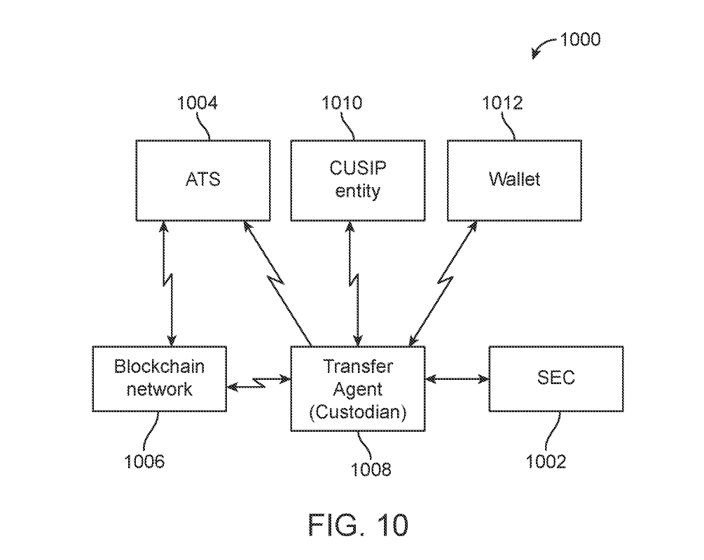

FIG. 10 illustrates a concept 1000 of a transfer agent 1008 serving as a qualified custodian as that term is used by the SEC. A qualified custodian can be a person or entity such as a bank or registered broker, registered dealer or other individuals or entities who are responsible for customer funds and to follow custody rules as set forth by the Securities and Exchange Commission. Specifically, there was an SEC investment management position in a 2013 report which permitted certificated private securities not to be in custody with a qualified custodian if (1) the client is a pooled investment vehicle that complies with the audit exception, (2) the prior consent of the issuer or its other holders is required to transfer ownership, (3) ownership of the security is recorded on the books of the issuer or its transfer agent in the name of the client, (4) the private stock certificate contains a restricted legend, and (5) the private stock certificate is appropriately safeguarded by the registered investment advisor and can be replaced upon loss or destruction (Certificated Private Securities). This disclosure applies the principle to this scenario where the individual owner of a security blockchain-based token can have their ownership representation, as one might with the normal stock certificate, in the form of a smart contract or represented by the certified records maintained by the transfer agent 1008. Thus, the concepts described herein involve enabling a transfer agent that stores or records data associated with blockchain-based trades in which utilizes embedded unique identifiers within each respective token associated with the trade as well as potentially unique identifiers are associated with the respective wallets of participants in a trade to be deemed a qualified custodian over those security tokens. As such, the transfer agent maintaining such records would be allowed to offer services such as account administration, transaction settlement, collection of dividends and interest payments, tech support or foreign-exchange support. Furthermore, a transfer agent might have the right to assert possession over the security tokens in connection with legal action, such as a power of attorney and so forth. This disclosure includes all of the technical functionality that can be associated with a transfer agent 1008 that has a status formally of being a custodian or qualified custodian in compliance with whatever rules now existing or generated in the future by the Securities and Exchange Commission. Therefore, all such functionality related to account administration, selling transactions, collecting dividends and interest payments, providing tech support, stopping or cancellation of hacked tokens, reissuing of remedial new tokens, and so forth can be claimed from the standpoint of the functionality of the transfer agent 1008. In many cases, that functionality would be performed in conjunction with an alternative trading system 1004, a CUSIP entity 1010, one or more wallets 1012, and even the blockchain network itself 1006. Any interactions or functions with one or more of these various external entities to the transfer agent 1008 can occur in order to achieve a respective service offering associated with a blockchain-based security token.

As shown in FIG. 10, the transfer agent 1008 can be registered with the appropriate government entity such as the SEC 1002. The unique identifiers embedded in tokens can be utilized to identify wallets or beneficial owners of respective tokens. An alternative trading system 1004 can report transactions which identify buyers, sellers, and tokens to the transfer agent 1008. As the digital assets are blockchain-based, the alternative trading system 1004 would also record the transactions separately on the blockchain network 1006. The transfer agent 1008 would be permitted to act as a custodian having a certified record of transactions to maintain. Typically, standard custodians safeguard an individual's financial assets. According to the United States definition, a person who owns a street name, security, and is not a member of exchange holds the securities through a registration chain which involves a custodian or a number of custodians. Responsibilities of the custodian include holding and safekeeping the assets as securities, arranging settlement of purchases and sales and deliveries in and out of such securities, and collecting information on income from the assets and administer tax withholding documents, and foreign tax reclamation. The custodian can administer voluntary or involuntary corporate actions on securities, such as stock dividends, stock splits, business combinations, tender offers, bond calls, etc. The custodian can provide information on the securities in their issuers such as annual general meetings related proxies and can maintain currency or cash, bank accounts, affect deposits and withdrawals and manage other transactions. Other services can be provided such as managing mutual funds, fund accounting, administration, legal, compliance and tech support services. Any of these services can also be performed by transfer agent acting as a custodian in the context of blockchain-based security tokens.

In another aspect of this disclosure, anti-money laundering (AML) processes may also be built into the issuance of tokens. Such a structure can include AML procedures to identify purchasers and sellers such as through the user of identifiers as disclosed herein. Know your client (KYC) requirements may also relate to being accredited or qualified purchasers, which is another important feature by way of investor protections. In a regulation D 506(c) offering under general solicitation, for example, the issuer can advertise to anyone and any inbound investor has to be accredited. A retail investor may not be allowed to make the purchase of a token offering under regulation D. These types of identification requirements and data associated with being a qualified investor can be embedded within one or more of the tokens or the smart contract. A verification and validation process for investors may be executed to confirm that an investor meets all regulatory requirements. For example, a service (such as a transfer agent) could provide personalized verification data associated with a potential investor to a token issuer or to a smart contract such that a particular token holder can be identified and qualified properly (e.g., does the inventors have enough income, net assets, experience, etc., to purchase the tokens?), and so forth. The purchaser may provide access to a service or to their financial data such that an automatic access could be provided through an application programming interface (API), for instance, for analyzing their capabilities.

The smart contract can include programming or functionality that receives an initial identification of a potential purchaser of tokens in the offering, and accesses databases that are authorized by the potential investor to evaluate the credit worthiness or financial condition of the investor and returns a confirmation that the investor is accredited or not. The smart contract could access, through an API or other communication mechanism, the various entities holding the data (banks, mortgage companies, car dealerships, brokers, etc.), which may be about, among other things, a home value, a bank account, investments, debt, historical financial data, and so forth for the investor to make the evaluation. The smart contract could also perform this function on a periodic basis as in some cases accreditation is to occur every 6 months. The tokens could also include parameters that tie the ongoing yield, dividend and/or rewards to the accreditation confirmation of the token holder. For example, the yield could go down or up if the smart contract, 6 months into the operation, identifies that the token holder is no longer accredited, some other event occurs which increases or decreases risk, and so forth.

Once the token is embedded with an accredited holder identification and status, the smart contract may be subject to various resale regulations. For example, the token may be subject to a 12-month resale provision for tax purposes or other restrictions in the United States. If someone tries to transfer the token, a multisignature confirmation approach could be implemented through the smart contract that prevents the token holder from selling that token before the 1-year anniversary. Thus, regulations can be implemented through the smart contract in this manner. As noted above, updates to regulations can also be provided to the smart contract such that its processing of dividends, restrictions on sale, and so forth can be according to the current regulatory environment.

In the scenario of a Regulation S offering, the token can be embedded with a regulatory parameter, which allows a user to sell the token to a foreign investor after 40 days. If a US investor then later buys that token, the smart contract can cause it to return to a 12-month sale restriction.

The discussion above provides a number of examples of how different offerings with different regulatory structures can be baked into tokens to identify the type of offering associated with the token, which information can then be communicated to or also provided to a smart contract that is carrying out the lifecycle of the tokens and their return on investment provisions.

In another aspect, the token can be embedded with a provision that identifies the token as owned by an insider of the issuer. The identification can provide more detailed information about the insider or may be more generic. For example, if the token is owned by the CEO of the issuing entity, that information could be made available or embedded within the token. If the token holder is more of an affiliate of the issuing entity, and thus not in a key strategic position, that information could be provided as well. This information may be useful in terms of providing transparency when tokens are sold or when dividends rewards or yields are provided. This feature can be provided as an aspect of investor protection. Also, in the case of a potential purchaser of the issuing entity or of an individual token or a group of tokens, the purchaser can be aware that he or she is buying insider tokens. This information can also be dynamic where the status of a token holder may change. For example, an individual who buys tokens from the issuing entity may later join the company on their Board of Directors. Further, a CFO may hold tokens as an insider that then leave the company and no longer have an insider status. The parameters that may be embedded within individual tokens can include data that encompasses and reports the various ways of defining an insider for purposes of that token or issuing entity.

In addition, the parameters that provide dividends yields or rewards may also vary for insiders. The parameters may be enhanced or reduced for purposes of fairness or transparency where insider traders receive a specialized type of return. Using the smart contract, data can be provided with respect to, for example, different aspects of the return on investment for insiders versus average investors. All of the insider tokens can be tracked for their particular type of return relative to other investors. Therefore, if the insider tokens receive a higher yield or return, that information can be made transparent to all token holders or to those who have access to the data from the smart contract.

The smart contract can receive information about citizenship, geographic location, accredited characteristics, and so forth of sellers and buyers of tokens in a marketplace and cause or implement any regulatory changes in those transactions. Thus, restrictions on sale, modifications of yield, dividends, and/or rewards, changes in blockchain analyses and recordation requirements, and so forth, can be implemented by the smart contract as programmed and can be based on the various points of data that would be required to carry out regulatory requirements. All of the incoming and outgoing communications associated with the smart contract are included within this process. Knowing this information about buyers and sellers can also be utilized to generate communication campaigns or advertising campaigns such that a specifically defined subset of buyers and sellers can be targeted for certain information.

The various external data sources would provide buyer and seller information. For example, an investor in a foreign country as well as an investor in the United States could register with the service, which provides their confirmed status, of any type, which impacts how regulations are applied. Citizen status or changes to citizen status could be provided to the smart contract, which could cause a change in a regulatory requirement or function of the smart contract. Various embodiments disclosed herein can be claimed from the standpoint of the smart contract, the token holder, the issuer, or from the standpoint of the third party service (such as a transfer agent 806 registered with the SEC) providing accreditation data, backup data associated with blockchain transactions, an audit trail, or other data. Thus, any steps performed by any individual entity in this process can be described and claimed as part of this disclosure.

In one aspect, investors could have in a digital wallet stored locally, or at a network service, verified data that identifies and is trusted to properly identify their accreditation status, citizenship, geographic location, and so forth. In some offerings, self-identification of accreditation is not acceptable. Thus, in situations where the issuing entity has the obligation to confirm the accreditation status of a potential token holder, using an accreditation wallet or network-based confirmation service can enable the issuing entity to fulfill their requirements through the implementation of the smart contract which would communicate with and retrieve the authorization data, or unique identification data, from an accreditation digital wallet or an accreditation service. For example, the data can be retrieved through a specific API with a holder of an individual retirement account (IRA) or other investment accounts of the buyer, the buyer's mortgage holder, or any other entity that has relevant data associated with the buyer's accreditation status. The smart contract can be authorized to retrieve that data and confirm their status to fulfil the issuing entity's obligation.

A third party service can also perform this function. The accreditation for a buyer can also be stored on a blockchain and verified through a verification algorithm. Each periodic confirmation of their accreditation status can be added to the buyer's accreditation blockchain. This approach improves the process by resolving the inherent conflict of the situation where the issuer is required to confirm the accredited status of potential buyers. Further, issuers may not even really have the capability or expertise to properly accredit buyers. Using a digital wallet or third party verifier enables a token to be created and embedded as a “clean” token that is issued to a confirmed accredited buyer. Such a clean token is better configured for resale as well. Multi-signatory requirements can be required for any aspect of this disclosure to confirm data or for security purposes.

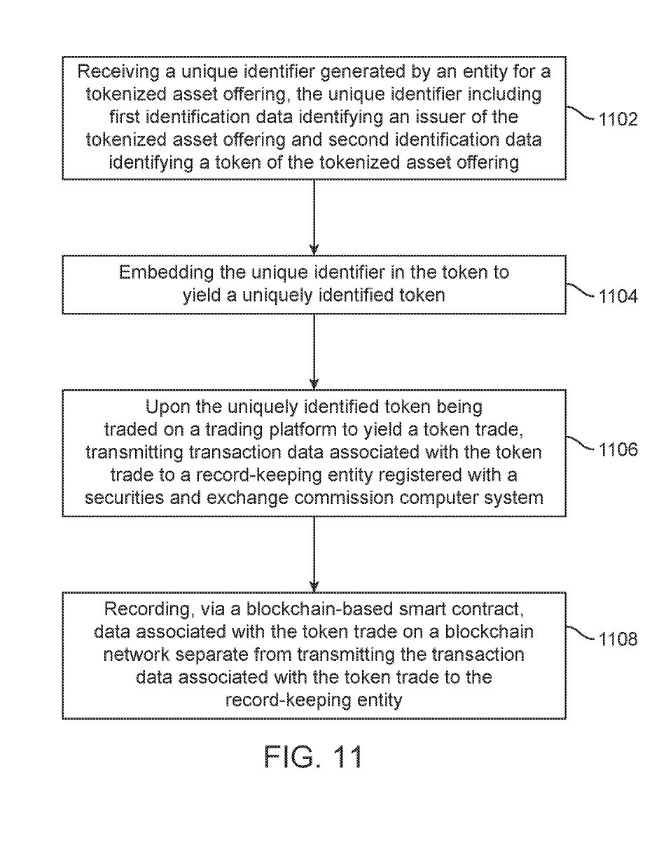

FIG. 11 illustrates a method embodiment. The method includes receiving a unique identifier generated by an entity for a tokenized asset offering, the unique identifier including first identification data identifying an issuer of the tokenized asset offering and second identification data identifying a token of the tokenized asset offering (1102), embedding the unique identifier in the token to yield a uniquely identified token (1104) upon the uniquely identified token being traded on a trading platform to yield a token trade, transmitting transaction data associated with the token trade to a record-keeping entity registered with a securities and exchange commission computer system (1106) and recording, via a blockchain-based smart contract, data associated with the token trade on a blockchain network separate from transmitting the transaction data associated with the token trade to the record-keeping entity (1108). The token can include a security token that is treated or considered a security under the legal guidelines. The unique identifier can be one of a CUSIP unique identifier, an ISIN unique identifier or a CINS unique identifier, or some other identifier associated with a standardized protocol.

The method can further include associating a wallet unique identifier to a cryptocurrency wallet that stores the token. Transmitting the transaction data associated with the token trade further can also include transmitting the unique identifier to the record-keeping entity to identify at least one of a buyer and a seller associated with the token trade. Additionally, the method can also include determining that a stored token in the cryptocurrency wallet has been stolen by a hacker, wherein the stored token comprises a stored token unique identifier to yield a hacked token, receiving an instruction from the record-keeping entity to stop or cancel the hacked token and generating a replacement token for the hacked token, wherein the replacement token comprises a replacement token unique identifier.

In yet a further aspect, the method can include embedding a respective unique identifier in each respective token of a tokenized asset offering from an issuer to yield uniquely identified tokens. As respective buyers purchase tokens from the tokenized asset offering to yield respective purchased, uniquely identified tokens per buyer, the method can include transmitting respective identification data associated with each respective purchased, uniquely identified token per buyer and buyer identification data to a record-keeping entity which is registered with a government securities regulatory entity. When a number of buyers registered with the government securities regulatory entity meets a threshold number of buyers, the method can include initiating a compliance requirement for the issuer.

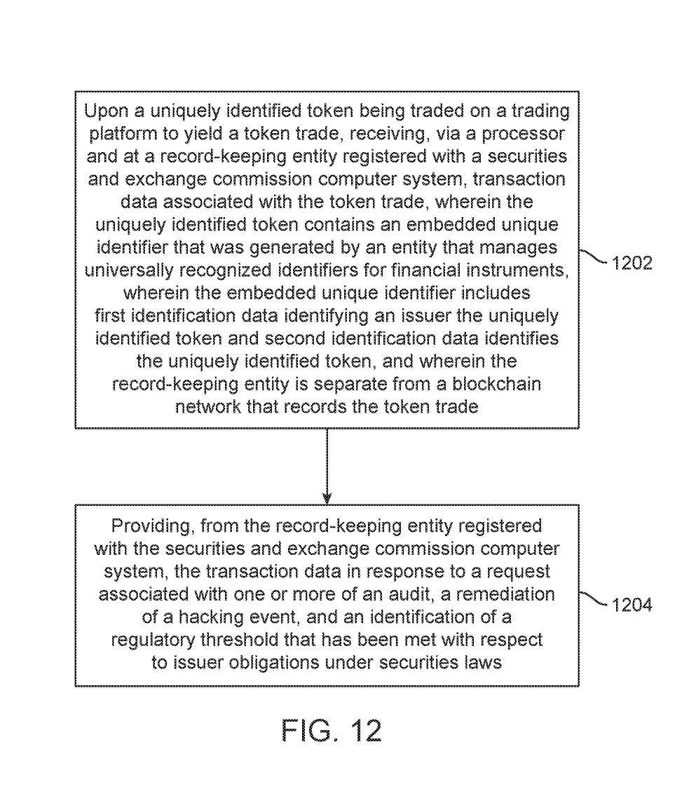

FIG. 12 illustrates another example method from a standpoint of a transfer agent and some of the functionality disclosed related to that entity. A method in this regard includes upon a uniquely identified token being traded on a trading platform to yield a token trade, receiving, via a processor and at a record-keeping entity registered with a securities and exchange commission computer system, transaction data associated with the token trade, wherein the uniquely identified token contains an embedded unique identifier that was generated by an entity that manages universally recognized identifiers for financial instruments, wherein the embedded unique identifier includes first identification data identifying an issuer the uniquely identified token and second identification data identifies the uniquely identified token, and wherein the record-keeping entity is separate from a blockchain network that records the token trade (1202).

The method also includes providing, from the record-keeping entity registered with the Securities and Exchange Commission computer system, the transaction data in response to a request associated with one or more of an audit, a remediation of a hacking event, and an identification of a regulatory threshold that has been met with respect to issuer obligations under securities laws (1204).

The method can include receiving a wallet unique identifier to a cryptocurrency wallet that is associated with one of a buyer or a seller in connection with the token trade. Upon a determination that a stored token in the cryptocurrency wallet has been stolen by a hacker, wherein the stored token includes a stored token unique identifier to yield a hacked token, the method can include providing an instruction from the record-keeping entity to a trading platform to stop or cancel the hacked token and providing an instruction to the trading platform to generate a replacement token for the hacked token, wherein the replacement token comprises a replacement token unique identifier.

In another aspect, the method can include embedding a respective unique identifier in each respective token of a tokenized asset offering from an issuer to yield uniquely identified tokens. As respective buyers purchase tokens from the tokenized asset offering to yield respective purchased, uniquely identified tokens per buyer, receiving, at the record-keeping entity which is registered with a government securities regulatory entity, respective identification data associated with each respective purchased, uniquely identified token per buyer and buyer identification data to and, when a number of buyers registered with the government securities regulatory entity meets a threshold number of buyers, initiating a compliance requirement for the issuer.

Various embodiments can be claimed from the standpoint of any entity disclosed herein. For example, a crypto currency wallet can be claimed, which includes the embedded unique identifier for that wallet, and which includes the functionality necessary to communicate the unique identifier and appropriate transactions in response to requests from other entities that are authorized. Claims can be drafted towards the blockchain network that might interact with other entities to enable the custodial functionality of the transfer agent, remedial activities associated with generating replacement security tokens for hacked security tokens, canceling or stopping trades associated with hacked tokens, and so forth. Functionality can also be claimed from the standpoint of a CUSIP or similar entity that receives requests for new CUSIP Numbers associated with blockchain-based tokenized asset offerings, analyzes, characteristics associated with the tokenized asset offering and generating a global uniform unique code that can identify individual tokens, in connection with a token offering of an issuer.

In one example, an alternative trading system 1004 can include a processor and a computer-readable storage device storing instructions which, when executed by the processor, causes the processor to perform certain operations. The operations can include managing a trade of a token associated with a blockchain-based tokenized asset offering to yield a token trade, when the token includes an embedded unique identifier which was generated by an entity that generates universally recognized identifiers for financial instruments, the embedded unique identifier includes first identification data identifying an issuer of the blockchain-based tokenized asset offering and second identification data identifying the token. Other operations can include, based on the token trade, transmitting, via a processor, transaction data associated with the token trade to a record-keeping entity registered with a Securities and Exchange Commission computer system and recording, via a blockchain-based smart contract, data associated with the token trade on a blockchain network separate from transmitting the transaction data associated with the token trade to the record-keeping entity.

In one aspect, the function of transmitting the transaction data associated with the token trade further includes transmitting a wallet unique identifier of a cryptocurrency wallet to the record-keeping entity to identify at least one of a buyer and a seller associated with the token trade. The computer-readable storage device of the alternative trading system can include additional instructions which, when executed by the processor, causes the processor to perform operations including determining that a stored token in the cryptocurrency wallet has been stolen by a hacker, wherein the stored token comprises a stored token unique identifier to yield a hacked token, receiving an instruction from the record-keeping entity to stop or cancel the hacked token and generating a replacement token for the hacked token, wherein the replacement token comprises a replacement token unique identifier.

In some embodiments, the computer-readable storage devices, mediums, and or memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. Any token or structure/function disclosed herein can apply to a tokenized asset offering or a security token offering.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

It should be understood that features or configurations herein with reference to one embodiment or example can be implemented in, or combined with, other embodiments or examples herein. That is, terms such as “embodiment,” “variation,” “aspect,” “example,” “configuration,” “implementation,” “case,” and any other terms which may connote an embodiment, as used herein to describe specific features of configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various embodiments or examples described herein, and their associated features, can be combined with each other in any combination.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa. The word “exemplary” is used herein to mean “serving as an example or illustration.” Any aspect or design described herein as “exemplary” is not necessarily to be construed as preferred or advantageous over other aspects or designs.

Moreover, claim language reciting “at least one of” a set indicates the one member of the set or multiple members of the set satisfy the claim. For example, claim language reciting “at least one of A, B, and C” or “at least one of A, B, or C” means A alone, B alone, C alone, A and B together, A and C together, B and C together, or A, B, and C together.

What is claimed is:

1. A method comprising:
receiving a unique identifier generated by an entity for a tokenized asset offering, the unique identifier comprising first identification data identifying an issuer of the tokenized asset offering and second identification data identifying a token of the tokenized asset offering;
embedding the unique identifier in the token to yield a uniquely identified token; and
upon the uniquely identified token being traded on a trading platform to yield a token trade, transmitting, via a processor, transaction data associated with the token trade to a record-keeping entity registered with a securities and exchange commission computer system; and
recording, via a blockchain-based smart contract, data associated with the token trade on a blockchain network separate from transmitting the transaction data associated with the token trade to the record-keeping entity.

2. The method of claim 1, wherein the token comprises one of a security token and a cryptocurrency.

3. The method of claim 1, wherein the unique identifier comprises one of a CUSIP unique identifier, an ISIN unique identifier or a CINS unique identifier.

4. The method of claim 1, wherein the entity comprises a CUSIP global services entity that generates unique identifiers for financial instruments.

5. The method of claim 1, further comprising:
associating a wallet unique identifier to a cryptocurrency wallet that stores the token, wherein transmitting the transaction data associated with the token trade further comprises transmitting the wallet unique identifier to the record-keeping entity to identify at least one of a buyer and a seller associated with the token trade.

6. The method of claim 5, further comprising:
determining that a stored token in the cryptocurrency wallet has been stolen by a hacker, wherein the stored token comprises a stored token unique identifier to yield a hacked token;
receiving an instruction from the record-keeping entity to stop or cancel the hacked token; and
generating a replacement token for the hacked token, wherein the replacement token comprises a replacement token unique identifier.

7. The method of claim 1, further comprising:
embedding a respective unique identifier in each respective token of a tokenized asset offering from an issuer to yield uniquely identified tokens;
as respective buyers purchase tokens from the tokenized asset offering to yield respective purchased, uniquely identified tokens per buyer, transmitting respective identification data associated with each respective purchased, uniquely identified token per buyer and buyer identification data to a record-keeping entity which is registered with a government securities regulatory entity; and
when a number of buyers registered with the government securities regulatory entity meets a threshold number of buyers, initiating a compliance requirement for the issuer.

8. A method comprising:
upon a uniquely identified token being traded on a trading platform to yield a token trade, receiving, via a processor and at a record-keeping entity registered with a securities and exchange commission computer system, transaction data associated with the token trade, wherein the uniquely identified token contains an embedded unique identifier that was generated by an entity that manages universally recognized identifiers for financial instruments, wherein the embedded unique identifier comprises first identification data identifying an issuer the uniquely identified token and second identification data identifies the uniquely identified token, and wherein the record-keeping entity is separate from a blockchain network that records the token trade; and
providing, from the record-keeping entity registered with the securities and exchange commission computer system, the transaction data in response to a request associated with one or more of an audit, a remediation of a hacking event, and an identification of a regulatory threshold that has been met with respect to issuer obligations under securities laws.

9. The method of claim 8, wherein the uniquely identified token comprises one of a security token and a cryptocurrency.

10. The method of claim 8, wherein the embedded unique identifier comprises one of a CUSIP unique identifier, an ISIN unique identifier or a CINS unique identifier.

11. The method of claim 8, wherein the entity comprises a CUSIP global services entity that generates unique identifiers for financial instruments.

12. The method of claim 1, further comprising:
receiving the transaction data further comprises receiving a wallet unique identifier to a cryptocurrency wallet that is associated with one of a buyer or a seller in connection with the token trade.

13. The method of claim 12, further comprising:
upon a determination that a stored token in the cryptocurrency wallet has been stolen by a hacker, wherein the stored token comprises a stored token unique identifier to yield a hacked token;
providing an instruction from the record-keeping entity to a trading platform to stop or cancel the hacked token; and
providing an instruction to the trading platform to generate a replacement token for the hacked token, wherein the replacement token comprises a replacement token unique identifier.

14. The method of claim 8, further comprising:
embedding a respective unique identifier in each respective token of a tokenized asset offering from an issuer to yield uniquely identified tokens;
as respective buyers purchase tokens from the tokenized asset offering to yield respective purchased, uniquely identified tokens per buyer, receiving, at the record-keeping entity which is registered with a government securities regulatory entity, respective identification data associated with each respective purchased, uniquely identified token per buyer and buyer identification data to; and
when a number of buyers registered with the government securities regulatory entity meets a threshold number of buyers, initiating a compliance requirement for the issuer.

15. An alternative trading system, comprising:
a processor; and
a computer-readable storage device storing instructions which, when executed by the processor, causes the processor to perform operations comprising:
managing a trade of a token associated with a blockchain-based tokenized asset offering to yield a token trade, when the token comprises an embedded unique identifier which was generated by an entity that generates universally recognized identifiers for financial instruments, the embedded unique identifier comprising first identification data identifying an issuer of the blockchain-based tokenized asset offering and second identification data identifying the token;
based on the token trade, transmitting, via a processor, transaction data associated with the token trade to a record-keeping entity registered with a securities and exchange commission computer system; and
recording, via a blockchain-based smart contract, data associated with the token trade on a blockchain network separate from transmitting the transaction data associated with the token trade to the record-keeping entity.

16. The alternative trading system of claim 15, wherein the token comprises one of a security token and a cryptocurrency.

17. The alternative trading system of claim 15, wherein the embedded unique identifier comprises one of a CUSIP unique identifier, an ISIN unique identifier or a CINS unique identifier.

18. The alternative trading system of claim 15, wherein the entity comprises a CUSIP global services entity that generates unique identifiers for financial instruments.

19. The alternative trading system of claim 15, wherein transmitting the transaction data associated with the token trade further comprises transmitting a wallet unique identifier of a cryptocurrency wallet to the record-keeping entity to identify at least one of a buyer and a seller associated with the token trade.

20. The alternative trading system of claim 19, wherein the computer-readable storage device stores additional instructions which, when executed by the processor, causes the processor to perform operations further comprising:
determining that a stored token in the cryptocurrency wallet has been stolen by a hacker, wherein the stored token comprises a stored token unique identifier to yield a hacked token;
receiving an instruction from the record-keeping entity to stop or cancel the hacked token; and
generating a replacement token for the hacked token, wherein the replacement token comprises a replacement token unique identifier.
